(19) United States
(12) Patent Application Publication
(10) Pub. No.: US 2019/0107672 A1
(43) Pub. Date: Apr. 11, 2019

(54) NON-PLANAR WAVEGUIDE STRUCTURES

(71) Applicant: GLOBALFOUNDRIES INC., GRAND CAYMAN (KY)

(72) Inventor: Ajey P. JACOB, Watervliet, NY (US)

(21) Appl. No.: 15/725,524

(22) Filed: Oct. 5, 2017

(51) Int. Cl. G02B 6/122; G02B 6/132

(52) U.S. Cl. CPC G02B 6/122; G02B 2006/12097; G02B 6/132

(57) ABSTRACT

The present disclosure generally relates to semiconductor structures and, more particularly, to non-planar waveguide structures and methods of manufacture. The waveguide structure includes: non-planar structures composed of a first material; a cladding layer over the non-planar structures composed of a second material; and a material formed over the cladding layer.

### FIELD OF THE INVENTION

The present disclosure generally relates to semiconductor structures and, more particularly, to non-planar waveguide structures and methods of manufacture.

### BACKGROUND

Photonics chips can require relatively long waveguides, i.e., several micrometers to centimeters, depending on the application. Examples of such devices include microfluidics/photonics, amongst other examples. In certain applications, these devices can be designed having a device length of over 100 μm, with some devices being hundreds of micrometers in length. Due to the length, these devices may not be suitable for applications requiring dense photonic integration, such as a system on chip, for example. This is particularly the case in devices where longer silicon waveguides are required, where it also may be difficult for the waveguides to be made shorter to satisfy certain ground rules.

### SUMMARY

In an aspect of the disclosure, a waveguide structure comprises: non-planar structures composed of a first material; a cladding layer over the non-planar structures composed of a second material; and a material formed over the cladding layer.

In an aspect of the disclosure, a structure comprises: a plurality of cladded core structures configured to propagate an optical wave in a non-planar geometry; and an upper layer formed over the non-planar waveguide.

In an aspect of the disclosure, a method comprises: forming non-planar structures composed of a first material which provide a non-planar optical path for an optical wave; forming a cladding layer over the non-planar structures composed of a second material; and forming a third material formed over the cladding layer.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1A shows an incoming structure, amongst other features, and respective fabrication processes in accordance with aspects of the present disclosure.

FIG. 1B shows wiring structures, amongst other features, and respective fabrication processes in accordance with aspects of the present disclosure.

FIG. 1C shows non-planar waveguides, amongst other features, and respective fabrication processes in accordance with aspects of the present disclosure.

FIG. 1D shows a cladding layer over the non-planar waveguides, amongst other features, and respective fabrication processes in accordance with aspects of the present disclosure.

FIG. 1E shows a plurality of non-planar waveguide structures, amongst other features, and respective fabrication processes in accordance with aspects of the present disclosure.

FIGS. 2A-2F show alternative structures, amongst other features, and respective fabrication processes in accordance with aspects of the present disclosure.

FIG. 3 shows a non-planar waveguide structure, amongst other features, and respective fabrication processes in accordance with aspects of the present disclosure.

FIGS. 4-6 show alternative non-planar waveguides, amongst other features, and respective fabrication processes in accordance with aspects of the present disclosure.

FIGS. 7A and 7B show implementations of non-planar waveguide structures, amongst other features, and respective fabrication processes in accordance with aspects of the present disclosure.

FIG. 8 shows a device implementing non-planar waveguide structures, amongst other features, and respective fabrication processes in accordance with aspects of the present disclosure.

FIG. 9 shows a schematic for implementing a non-planar waveguide structure, amongst other features, and respective fabrication processes in accordance with aspects of the present disclosure.

### DETAILED DESCRIPTION

The present disclosure generally relates to semiconductor structures and, more particularly, to non-planar waveguide structures and methods of manufacture. In embodiments, the non-planar waveguide structures include a non-planar, i.e., vertical and horizontal, propagation of an optical wave, which reduces the length needed for a waveguide in a planar direction. In embodiments, the non-planar waveguide structures have reduced footprints, resulting in aggressive dimensional scaling of the non-planar waveguide structures. Accordingly, and advantageously, by implementing the non-planar waveguide structures described herein, high density scaling of optical interconnects in devices can be achieved. Devices which can achieve a reduced footprint by implementing these non-planar waveguide structures include multimode interference (MMI) couplers, optical parametric amplifiers (OPA) and macrochips, amongst other examples.

The non-planar waveguide structures can be made of any materials having suitable refractive indexes, including materials which generally require longer waveguides, such as polymers or SiN, amongst other examples noted herein. In further embodiments, the non-planar waveguide structures can be comprised of quantum well materials and related structures. For implementation, the non-planar waveguides can be implemented with back end of the line (BEOL) structures and front end of the line (FEOL) structures of a CMOS circuit, while in embodiments the non-planar waveguide structures and CMOS circuits can be implemented with an interposer.

The structures of the present disclosure can be manufactured in a number of ways using a number of different tools. In general, though, the methodologies and tools are used to form structures with dimensions in the micrometer and nanometer scale. The methodologies, i.e., technologies, employed to manufacture the structure of the present disclosure have been adopted from integrated circuit (IC) technology. For example, the structures are built on wafers and are realized in films of material patterned by photolithographic processes on the top of a wafer. In particular, the fabrication of the structure uses three basic building blocks: (i) deposition of thin films of material on a substrate, (ii) applying a patterned mask on top of the films by photolithographic imaging, and (iii) etching the films selectively to the mask.

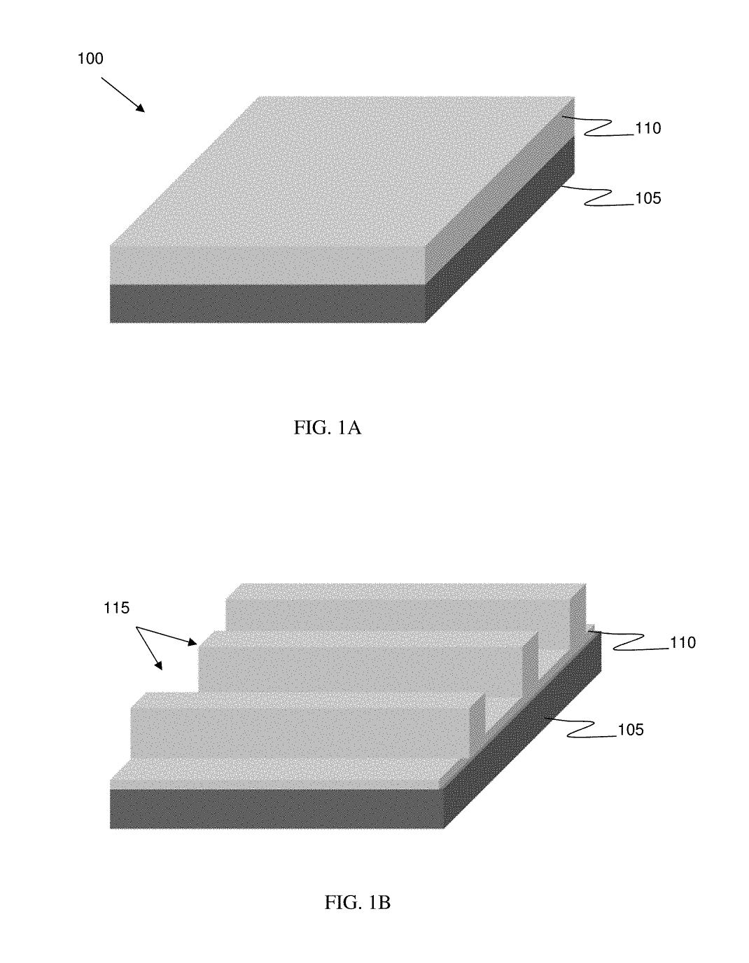

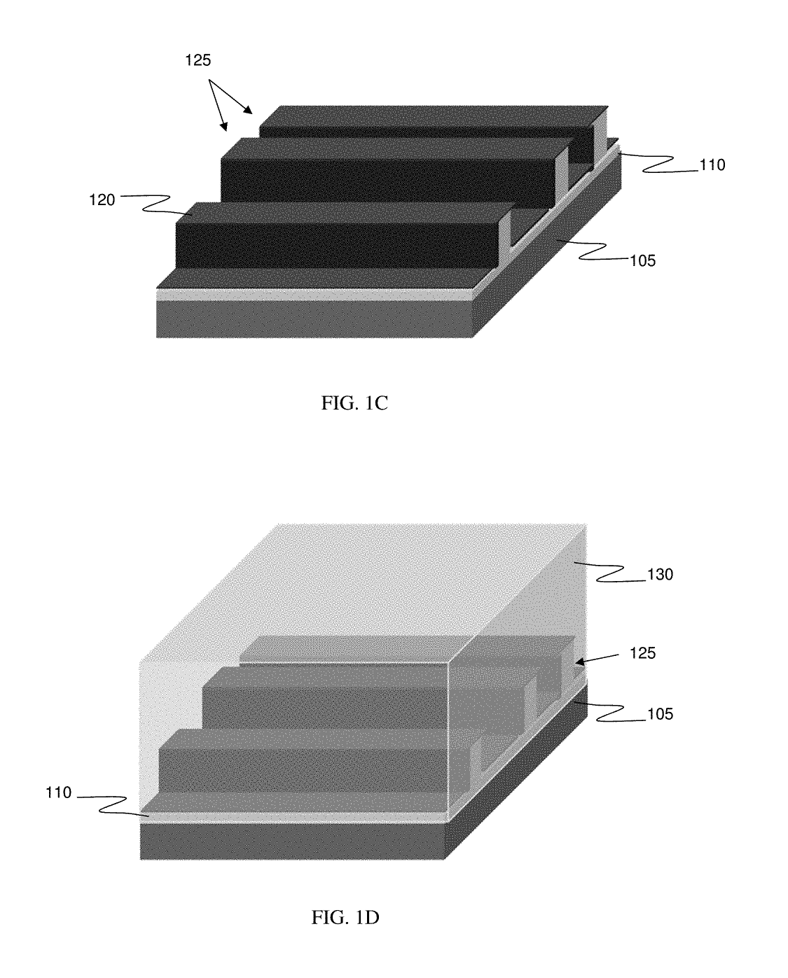

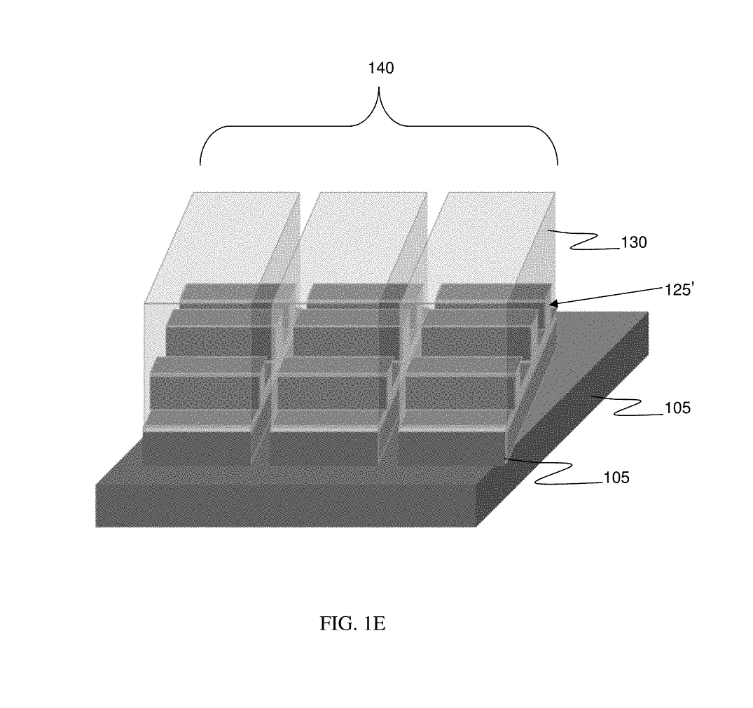

FIG. 1A shows an incoming structure and respective fabrication processes in accordance with aspects of the present disclosure. In particular, FIG. 1A shows a structure 100 comprising a substrate 105 and a cladding layer 110 as a first material. In embodiments, the substrate 105 can be any appropriate semiconductor material, e.g., bulk Si, SiGe, Sage, SiC, GaAs, GaN, GaP, InAs, InN, InP, AIN, AlAs, LiAlO₂, sapphire and other III/V or II/VI compound semiconductors or dielectrics such as SiN, polymers, etc. The cladding layer 110 can be any suitable cladding material, e.g., Si, SiO₂ or SiN or other polymer material, deposited over the substrate 105. Depending on the core compound structure, the cladding layer can also be another compound semiconductor material of a different refractive index.

In embodiments, the cladding layer 110 has a certain refractive index or index of refraction (n), which describes the propagation ability for an optical signal through the material. As an example, the cladding layer 110 can be comprised of a material having a refractive index of n=1. The cladding layer 110 can be deposited using conventional deposition processes, e.g., chemical vapor deposition (CVD), a spin-on process or by use of a doctor's blade followed by a UV-flood curing.

FIG. 1B shows an array of wiring structures 115 formed from the cladding layer 110 and therefore composed of the first material. The wiring structures 115 are non-planar structures which can take various shapes, such as rectangular, square, semi-circular, etc., amongst other examples. The wiring structures 115 can be formed using conventional lithography and etching processes, e.g., a reactive ion etching (RIE) process. For example, a resist formed over the layer 110 is exposed to energy (light) to form a pattern (opening). An etching process with a selective chemistry, e.g., RIE, will be used to form one or more trenches in the cladding layer 110 through the openings of the resist. The resist can then be removed by a conventional oxygen ashing process or other known stripants. In embodiments, the RIE process can be a timed etching process to ensure that the etching does not completely remove the cladding layer 110 over the substrate 105.

In FIG. 1C, a material 120, e.g., a core material, is deposited on the wiring structures 115, resulting in a plurality of non-planar waveguide structures 125. In this way, the non-planar waveguide structures 125 are cladded core structures configured to propagate an optical wave in a non-planar geometry. Examples of non-planar geometry include a rectilinear optical path or a semi-circular optical path, amongst other examples. In this way, the non-planar geometry includes both a vertical direction and a horizontal direction. The material 120 can be a cladding layer and can be composed of silicon or polymer material, for example, deposited by conventional deposition methods, e.g., CVD. In embodiments, the material 120 will be a different second material in comparison to the cladding layer 110, and can have a second refractive index larger than the first refractive index of the cladding layer 110, i.e., the first material. For example, the material 120 can have a refractive index of n=2, while the cladding layer 110 has a refractive index of n=1.

FIG. 1D shows an upper cladding layer 130 deposited and formed over the non-planar waveguide structures 125. The cladding layer 130 can be made of any suitable cladding material, e.g., SiO₂ or SiN, amongst other examples. In embodiments, the cladding layer 130 is a third material/upper layer and can be made of a material having a third refractive index less than the refractive index of the material 120. As an example, the material of the cladding layer 130 can have a refractive index n<2, while the material 120 has a refractive index n=2. In further embodiments, the cladding layers 110, 130 can be made of the same material. As an example, the cladding layers 110, 130 can both be made of a material having a refractive index n=1, while the core material 120 has a refractive index of n=2. In this way, the third refractive index is equal to the first refractive index and the second refractive index is different from the first and third refractive indexes, i.e., the second refractive index is greater than the first and third refractive indexes. In other embodiments, the cladding layer 130 can have a refractive index equal to the refractive index of material 120, i.e., the second material and the third material can have a same refractive index which are equal to one another. In embodiments, the cladding layer 130 can be deposited using a CVD process, or can be deposited by a spin-on process (when the cladding layer 130 comprises a polymer material). In embodiments, the non-planar waveguide structures 125 can also be cladded with air or other inert gas, i.e., the third material can be comprised of air.

FIG. 1E shows multiple non-planar waveguide structures 140 patterned from the structure of FIG. 1D. These non-planar waveguide structures 140 can be patterned by using conventional lithography and etching processes, e.g., a RIE process with a selective chemistry. For example, a resist formed over the cladding layer 130 is exposed to energy (light) to form a pattern (opening). An etching process with a selective chemistry, e.g., reactive ion etching (RIE), will be used to pattern the cladding layer 130 and underlying non-planar waveguide structures 125, through the openings of the resist. In this way, the non-planar waveguide structures 125 can be patterned into multiple non-planar waveguide structures 125′, each having a reduced footprint in comparison to other waveguides, such as silicon photonics waveguide structures, due to a reduced length in a planar direction needed to propagate a signal. The reduced footprint is achieved by enabling an optical wave from a signal to propagate in a non-planar geometry, i.e., vertical propagation, in addition to horizontal propagation. The multiple non-planar waveguide structures 140, i.e., the wiring (non-planar) structures 115 and the (cladding layer) material 120 which comprise the non-planar waveguide structures 125, along with the (third material) cladding layer 130, form a shape that provides a rectilinear optical path for the propagation of an optical wave.

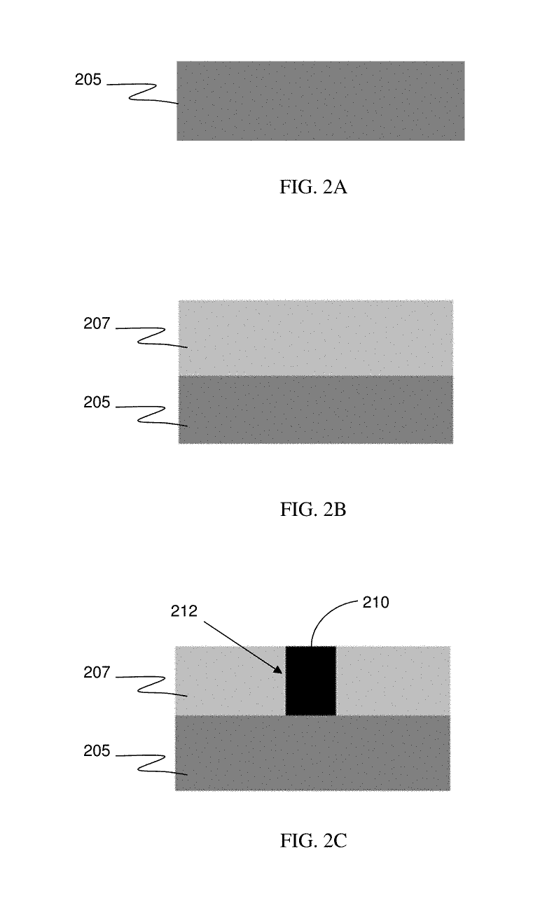

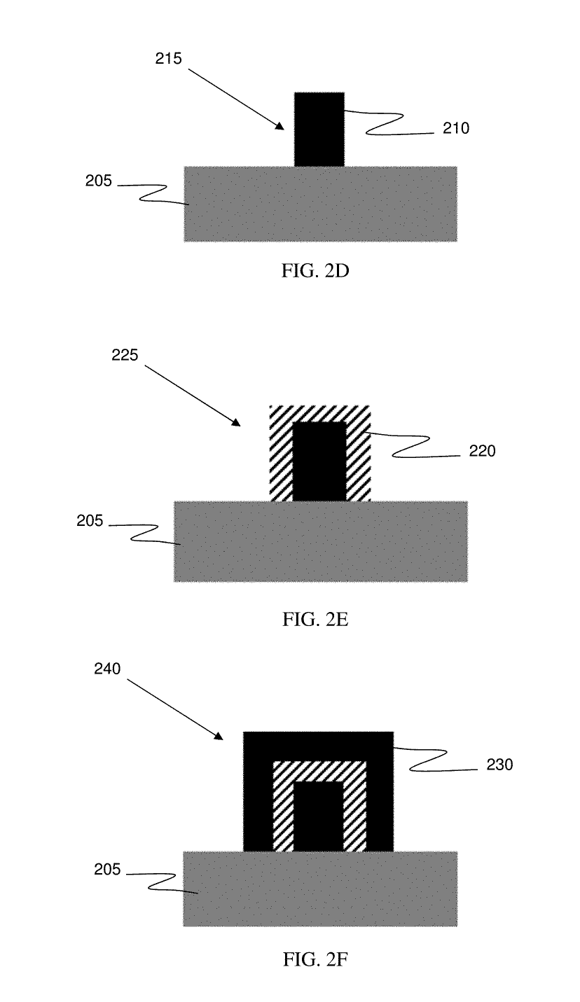

FIGS. 2A-2F show alternative structures and respective fabrication processes in accordance with aspects of the present disclosure. Specifically, FIGS. 2A-2F illustrate quantum waveguide structures comprising quantum wells, which can be fabricated either monolithically or separately, and which can be wafer bonded to the BEOL of a CMOS circuit. FIG. 2A shows a substrate 205 comprised of a Si material, such as a bulk silicon. FIG. 2B shows an insulator layer 207 deposited over the substrate 205 using conventional deposition processes, e.g., CVD. The insulator layer 207 can be comprised of SiO₂, for example. FIG. 2C shows a trench 212 formed in the insulator layer 207, exposing a portion of the underlying substrate 205. The trench 212 can be formed in the insulator layer 207 by a RIE process, as is known in the art.

A cladding layer 210 is deposited within the trench 212 and contacting the substrate 205. The cladding layer 210 can be deposited by a conventional deposition method, e.g., CVD process, to a height of the insulator layer 207, or a height above the insulator layer 207, which would be followed by a polishing process, e.g., a chemical mechanical polish (CMP), to a height of the insulator layer 207. The cladding material 210 can be any suitable quantum material, such as InP, for example. In embodiments, the cladding material 210 can have a refractive index of n=1. FIG. 2D shows the insulator layer 207 removed, leaving a non-planar structure 215 comprised of the cladding layer 210. In embodiments, the insulator layer 207 can be removed by any conventional process.

FIG. 2E shows a quantum well material 220 formed on the non-planar structure 215. The quantum well material material 220 can e.g., InGaAs, amongst other examples, deposited by conventional deposition processes, e.g., CVD process. The quantum well material 220 can be a quantum well material having a refractive index greater than the refractive index of the cladding layer 210, e.g., n=2. By having a reduced total length needed in a planar direction to propagate an optical wave, the non-planar waveguide structure 225 has a reduced footprint in comparison to other waveguides.

FIG. 2F shows a cladding layer 230 deposited over the quantum well material 220, forming a quantum well non-planar waveguide structure 240. The cladding layer 230 can be made of any suitable quantum well material, such as InP, amongst other examples. In embodiments, the cladding layer 230 can be made of a material having a refractive index less than the refractive index of the quantum well material 220, such as a material having a refractive index n<2, while the quantum well material 220 has a refractive index n=2. In further embodiments, the cladding layers 210, 230 can be made of the same material. As an example, the cladding layers 210, 230 can both be made of a material having a refractive index n=1, while the quantum well material 220 has a refractive index of n=2. In embodiments, the non-planar waveguide structure 225 may be cladded with air, i.e., the cladding layer 230 being comprised of air. The quantum well non-planar waveguide structure 240, i.e., the non-planar structure 215 and the quantum well material 220 which comprise the non-planar waveguide structure 225, and the (third material) cladding layer 230, form a shape that provides a rectilinear optical path for propagation of an optical wave. In embodiments, the rectilinear optical path can include horizontal and vertical optical paths for the propagation of the optical wave. In alternative embodiments, these structures can form a shape that provides a semi-circular optical path, which includes an arc shaped optical path, for the propagation of an optical wave.

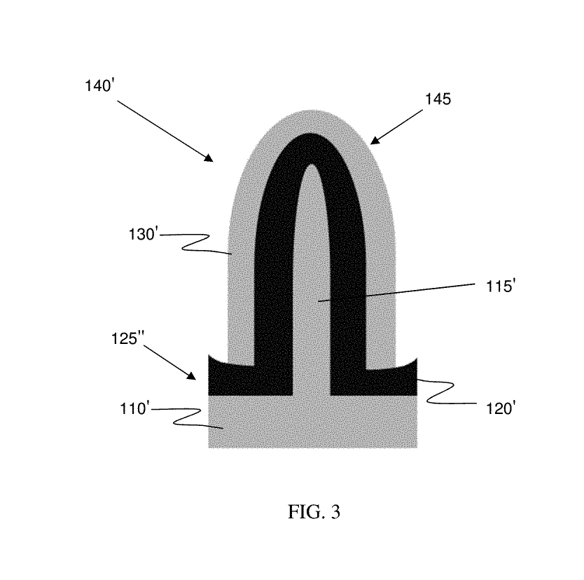

FIG. 3 shows a non-planar waveguide structure 140′ having an alternative shape, i.e., an arc shape 145, or a semi-circular or semi-spherical shape, in comparison to the non-planar waveguide structures 140, 240 of FIGS. 1A-2F. In embodiments, the non-planar waveguide structure 140′ can be formed by conventional CMOS processes followed by an epitaxial growth. For example, the cladding layer 110′ is patterned by a RIE patterning process to form the layer 115′ in an arc shape. This is followed by an epitaxial growth of the layer 120′ over the layer 115′, resulting in the layer 120′ having an arc shape. A layer 130′ is deposited over the layer 120′, also resulting in an arc shape. In this way, the arc shapes of the multiple layers 115′, 120′, 130′ form the arc shape 145 of the non-planar waveguide structure 140′.

In embodiments, the non-planar waveguide structure 140′ can be comprised of the same materials as non-planar waveguide structures 140, 240 to form the non-planar waveguide structure 125″, i.e., the cladded core structure. In alternative embodiments, the non-planar waveguide structure 140′ of FIG. 3 can be composed of a cladding layer 110′, and more particularly a layer (wiring structure) 115′ of SiO₂, a (core material) layer 120′ of Poly Si and a (cladding) layer 130′ of SiO₂. In further alternative embodiments, the non-planar waveguide structure 140′ of FIG. 3 can be composed of a layer 115′ of SiO₂, a layer 120′ of SiN and a layer 130′ of SiO₂. In still further alternative embodiments, the layers can include siloxane based polymers with two different refractive indexes for the core and the cladding materials, i.e., layer 120′ as the core and layers 115′, 130′ as the cladding materials. In still further embodiments, the non-planar waveguide structure 140′ of FIG. 3 can be composed of layers of II-V semiconductor compounds. For example, the structure can include a layer 115′ of InP, the non-planar waveguide structure 125″ comprised of a layer of InGaAS, and layer 130′ of InP. In any of the embodiments, the arc shape 145 will have an angle of less than 90 degrees, which can provide a relatively lower loss of optical wave propagation in comparison to non-planar waveguides having angles closer to 90 degrees.

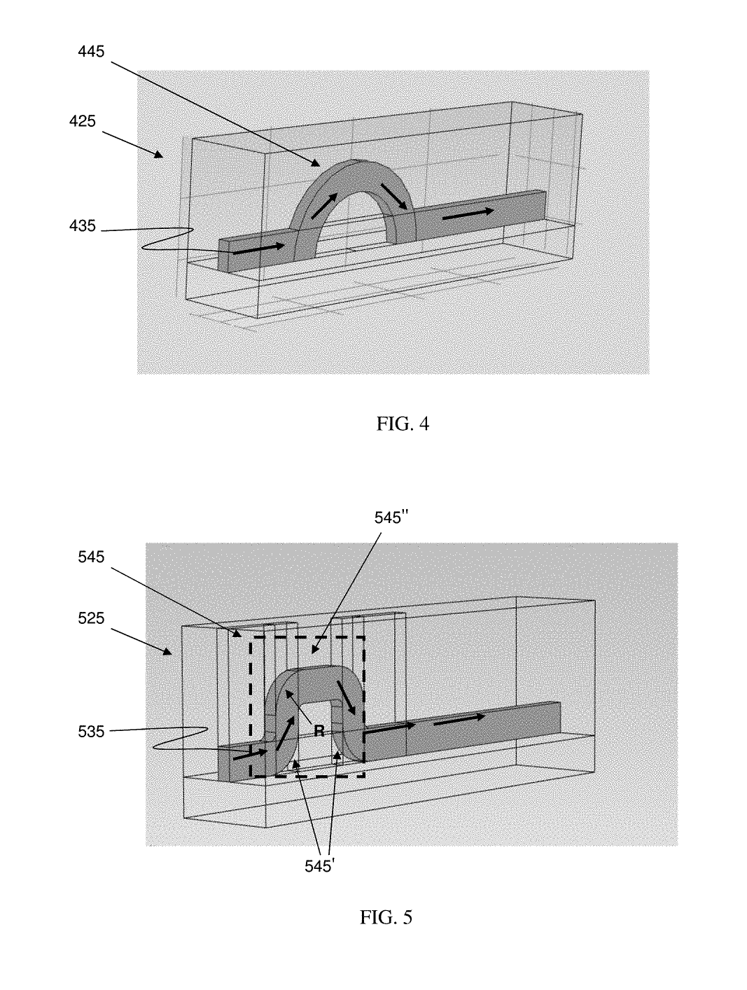

FIGS. 4-6 illustrate further alternative non-planar waveguide structures 425, 525, 625 in accordance with aspects of the present disclosure. Similar to the non-planar waveguide structure 125″ of FIG. 3, the non-planar waveguide structures 425, 525, 625 have angles less than 90 degrees, e.g., an arc shape, etc. In this way, the non-planar waveguide structures 425, 525, 625 can provide a relatively lower loss of propagation in comparison to non-planar waveguides having angles of 90 degrees, or closer to 90 degrees. In FIG. 4, an optical wave 435 is shown passing through the body of the non-planar waveguide structure 425, including passing through a semi-circular arc portion 445. As an example for dimensions, the non-planar waveguide structure 425 can have a length of 8 μm. In comparison, a planar waveguide would have a length of 10 μm to achieve an equal optical wave propagation. Therefore, in this example the non-planar waveguide structure 425 achieves a footprint reduction of 20%.

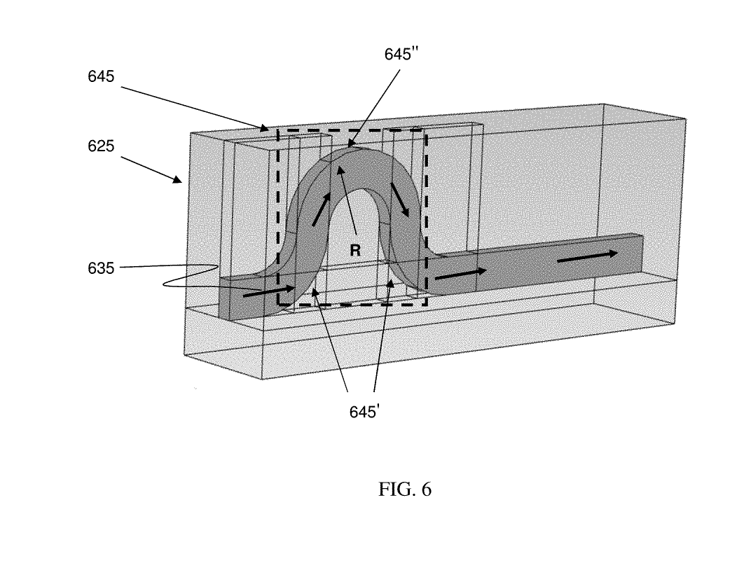

FIGS. 5 and 6 illustrate further examples of non-planar waveguide structures 525, 625 with angles of less than, equal to or greater than 90 degrees, being traversed by optical waves 535, 635, respectively. In FIG. 5, the non-planar waveguide structure 525 can have a radius of curvature of R, equal to 0.125 μm, forming the arc 545, resulting in the non-planar waveguide structure 525 having a total length of 8 μm. More specifically, the arc 545 includes non-planar portions 545′, e.g., arcs, leading to a vertical extend and an arc portion 545″. In embodiments, the non-planar portions 545′ can have angles close or equal to 90 degrees. The non-planar portions 545′ can also be 90 degrees. Further, the arc portion 545″ can also have angles connecting to the non-planar portions 545′ which are close to 90 degrees, providing a flatter surface for the arc 545. In this way, the non-planar waveguide 525 has a non-planar optical path which includes an arc 545 to provide an arc shaped optical path for the propagation of the optical wave 535.

In FIG. 6, the non-planar waveguide structure 625 has a further reduction in the footprint in comparison to the non-planar waveguide structure 525. As an example, the non-planar waveguide structure 625 can have a radius of curvature R equal to 0.5 μm for the arc 645. More specifically, the arc 645 includes non-planar portions 645′ e.g., arcs, that have a shallower angle than the non-planar portions 545′ of FIG. 5. The non-planar portion 645′ leads to a vertical leg and, thereafter, an arc portion 645″. Further, the arc portion 645″ can also have angles providing a semi-circular surface. In this example, the non-planar waveguide structure 625 would have a total length of 7 μm (achieving a 30% reduction in footprint compared to conventional structures). In this way, the non-planar waveguide structure 625 has a semi-circular optical path which includes an arc 645 to provide an arc shaped optical path for the propagation of the optical wave 635. Specifically, FIG. 6 shows that the semi-circular optical path includes at least one arc shaped optical path provided by the non-planar portion 645′, which leads to a vertical extent of the arc portion 645″, for the propagation of the optical wave 635. More specifically, FIG. 6 shows a semi-circular optical path provided by the arc 645, which includes two arc shaped optical paths provided by the non-planar portions 645′, with a vertical optical path 645″ therebetween.

As should be understood by those of skill in the art, increasing the radius of curvature further increases the height of the non-planar waveguide, thereby allowing for greater vertical propagation of the optical wave. For example, the non-planar waveguide structure can have a radius of curvature equal to 1 μm, with the arc having a length of 2 μm, resulting in the non-planar waveguide structure having a height of 3 μm and an overall length of the non-planar waveguide structure being equal to 5 μm. In comparison, a planar waveguide structure would need a length of 10 μm to achieve the same wave propagation. Therefore, increasing the radius of curvature to 1 μm allows for a footprint reduction of 50% for the non-planar waveguide structure.

Additional factors, such as materials, can also reduce the footprint of the non-planar waveguide structures described herein. As an example, the non-planar waveguide 625 can have a radius of curvature equal to 1 μm, and be cladded with air, resulting in a footprint reduction near or greater than 50%. In this way, having a radius of curvature equal to 1 μm and cladding the non-planar waveguide 625 with air, would result in the arc having a height of 2 μm and an arc length of 2 μm, while the non-planar waveguide would have a height of 5 μm and an overall length equal to 5 μm. In further examples, cladding the non-planar waveguide structure with SiO₂, along with a radius of curvature equal to 1 μm, would allow for a footprint reduction >50%. It should further be understood by those of skill in the art that the waveguide structures can be various shapes and sizes. For example, the non-planar waveguides can be rectangular, triangular, square-shaped, or circular, and any combination thereof, for example.

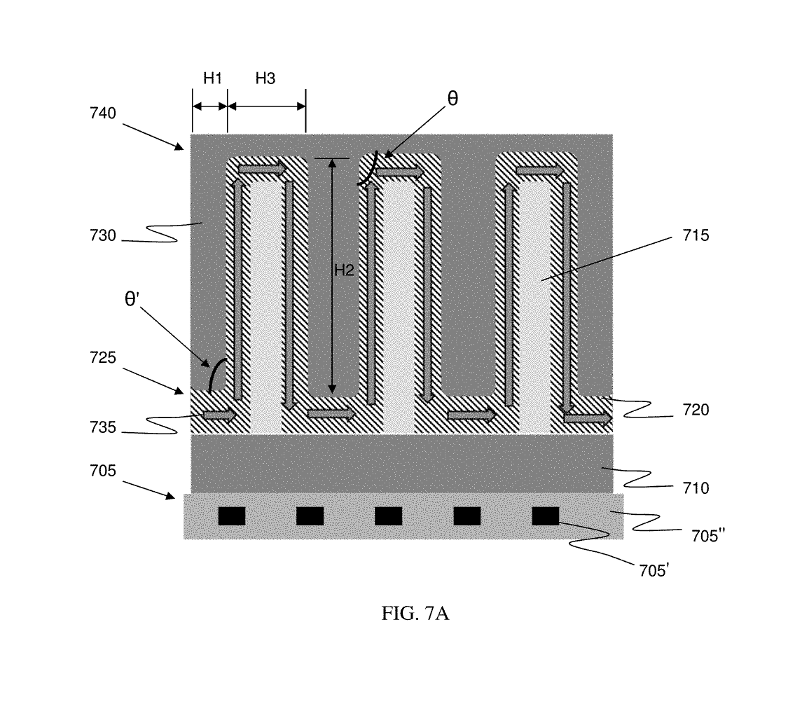

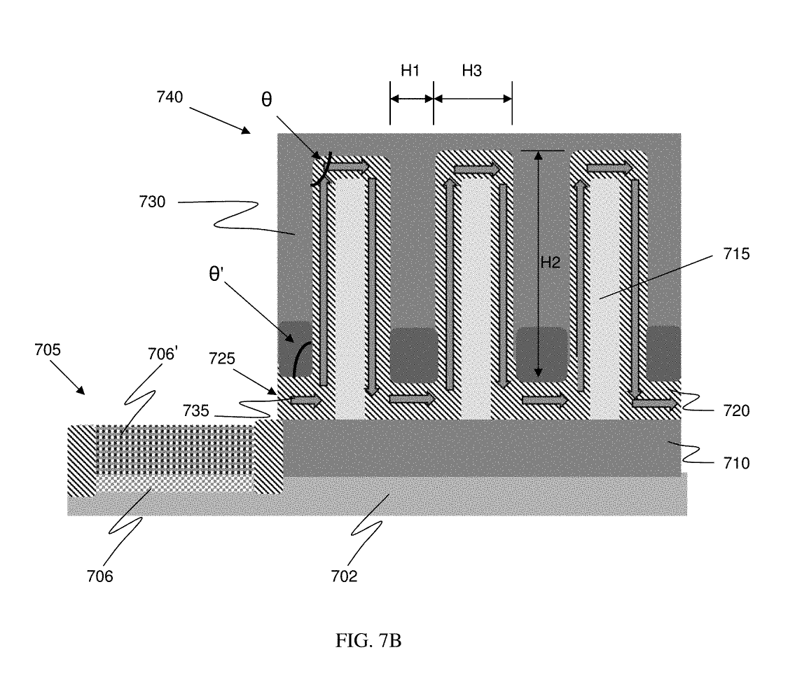

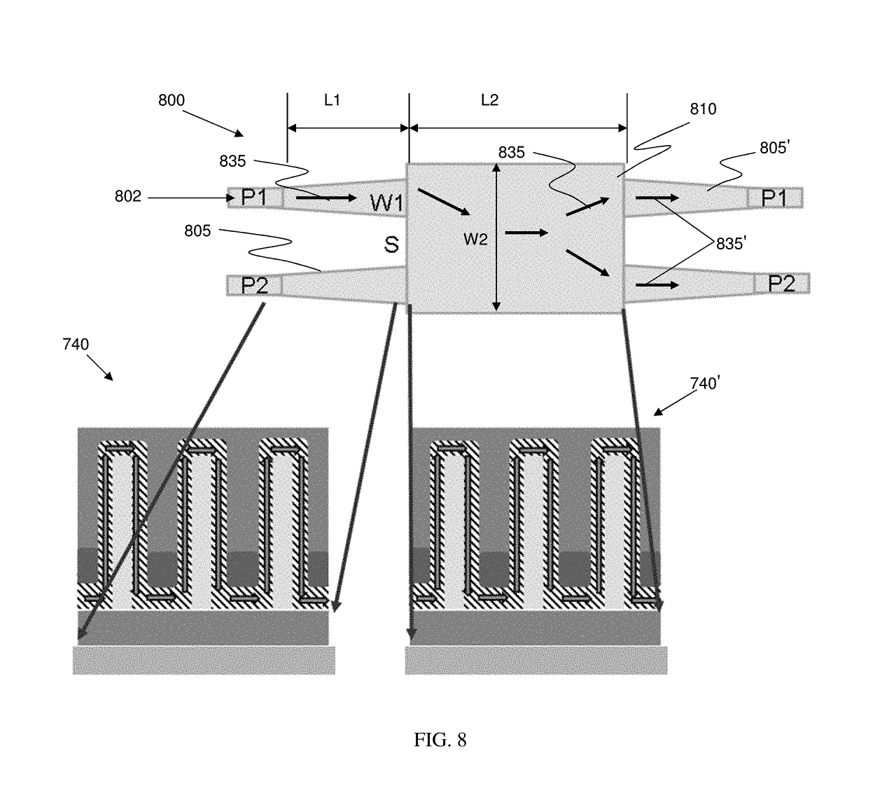

FIG. 7A illustrates the integration of the non-planar waveguide structure 740 onto a backside of an electronic device 705. More specifically, FIG. 7A illustrates the monolithic integration of the non-planar waveguide structure 740, including non-planar waveguide structure 725, into a backend of a CMOS circuit, i.e., back end of the line (BEOL) devices. In embodiments, the electronic device 705 is comprised of BEOL devices 705′ which can be any back end of the line structures including, e.g., wiring structures, interconnections, etc., in an insulator layer 705″. In embodiments, the non-planar waveguide structure 740 of FIG. 7A is composed of the same materials as the non-planar waveguide structures already described herein.

In addition, and as shown in FIG. 7A, angle θ represents the angle of the non-planar portions of the non-planar waveguide structure 740. In embodiments, 90°<θ>0° can be representative of the shapes shown in FIGS. 3-6, which provide a relatively lower loss of propagation in comparison to non-planar waveguide structures. The angles 90°<θ>0° can be at the junction between the legs H1, H2 and H3, which can be legs of different lengths for, e.g., arc shaped or circular shaped waveguide structures. Alternatively, θ can be about 90 degrees for rectangular or square shaped non-planar waveguide structures, depending on the lengths of the legs H1, H2, H3. For example, the angle θ′ between the legs H1 and H3 and the angle θ between H2 and H3, can both be about 90 degrees, forming a rectilinear shaped optical path that includes horizontal and vertical optical paths for the optical wave 735 to traverse. Therefore, the non-planar waveguide structure 740, i.e., the cladding layer 710, the non-planar waveguide structure 725 which comprises the non-planar structures 715, e.g., wiring structures, and the (cladding layer) material 720, and the (third material) upper cladding layer 730 form a shape that provides a rectilinear optical path for propagation of an optical wave. More specifically, the optical wave 735 can traverse along a horizontal direction until H2, in which the waveguide would follow a vertical direction until H3, in which the optical wave 735 would travel in a horizontal direction, for a single period, as an example. In embodiments, θ can be about 90 degrees for large differences between refraction indexes, e.g., when the materials used are III-V materials, which have a large contrast in the refraction indexes (n), i.e., n₁ vs n₂ vs n₃.

FIG. 7B illustrates the integration of the non-planar waveguide structure 740 with an electronic device 705, e.g., FEOL devices 706 and BEOL devices 706′, using an interposer 702. In embodiments, the non-planar waveguide structure 740 can be integrated before or together with the integration and fabrication of the interposer 702 and related devices. As shown in FIG. 7B, the waveguide structure can be composed of various dimensions H1, H2, H3, wherein the total length of the square or rectangular non-planar waveguide structure 740, e.g., “total length of the waveguide structure”=H2 (where H2 is the height of the waveguide structure)+H3 (width of the waveguide structure)+H1 (where H1 is the distance between the wave guides). Since the angles θ, θ′ between the legs H1 and H3 and between H2 and H3, respectively, can both be about 90 degrees, the optical wave 735 would traverse in a rectilinear optical path. In embodiments, such as those illustrated in FIGS. 5 and 6, the angles θ, θ′ between the legs H1 and H3 and between H2 and H3 can be greater than 90 degrees, which generates a more circular shaped non-planar waveguide.

FIG. 8 illustrates the application of the non-planar waveguide structures 740 used with a multimode interference (MMI) coupler 800. Examples of other devices can include an optical parametric amplifier (OPA) or a macrochip. In embodiments, the multimode interference (MMI) coupler 800 includes an input 802 comprising input legs 805, and an output with output legs 805′. The input and output can be tapered legs, as an example, with symmetry for both the input legs 805 and the output legs 805′. The input legs 805 and output legs 805′ include contacts P1, P2, which extend from a waveguide body 810. In embodiments, the legs 805, 805′ can each have a length L1 of 2 μm and a tapered width W1 of 1 μm and less, with the legs 805, 805′ separated by a space S=1 μm; although other dimensions are also contemplated herein. The waveguide body 810 can have a length L2 of about 5-15 μm; although other dimensions are also contemplated herein. In embodiments, the width of the MMI coupler can be found as W2=2W1+S+1 μm.

The MMI coupler 800 can split, couple or combine optical signals, depending on the application. For example, one application includes wave coupling into and out of a micro-ring or racetrack resonator based lasers or wavelength filters. In embodiments, an optical wave 835 from the input 802 traverses through a first non-planar waveguide 740 located within the input leg 805 of the MMI coupler 800. The optical wave 835 is outputted by the first non-planar waveguide 740 into a second non-planar waveguide 740′, which splits the optical wave 835 into multiple optical waves 835′. The optical waves 835′ are outputted by the output legs 805′.

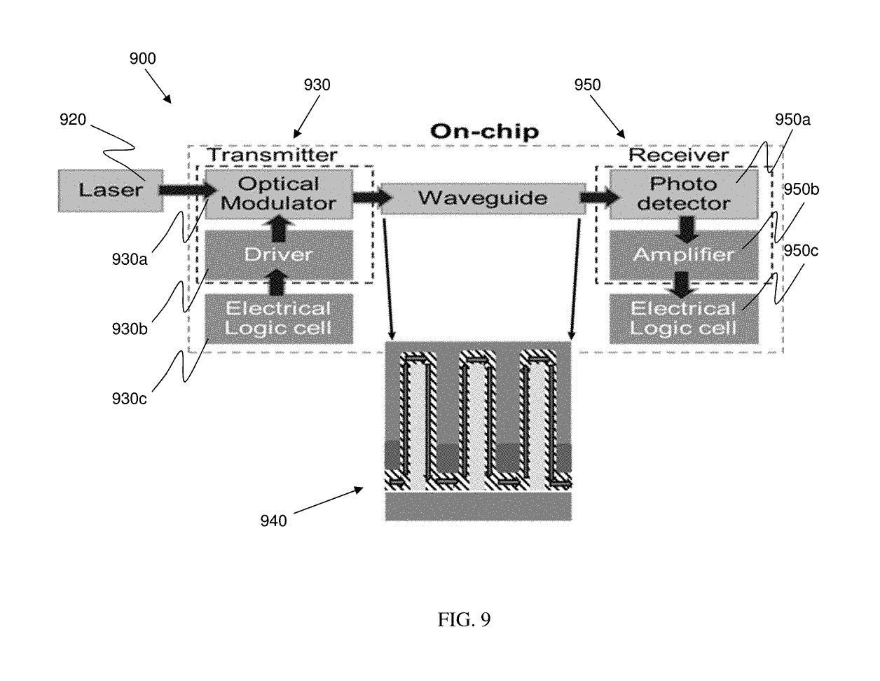

FIG. 9 illustrates a schematic 900 involving the implementation of a non-planar waveguide structure 940, with various components. In embodiments, the components can include a laser 920 or other light source inputted into a transmitter 930 comprised of an optical modulator 930a, a driver 930b, and electrical logic cell 930c which controls the driver 930b. The transmitter 930 will input the optical wave into the waveguide structure 910 which, in turn, will propagate the optical signal to a receiver 950. In embodiments, the receiver 950 comprises a photo detector 950a and an amplifier 950b, which can be controlled by an electrical logic cell 950c.

The method(s) as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A waveguide structure, comprising:
non-planar structures having a reduced horizontal length in a planar direction in comparison to a vertical length in a non-planar direction and the non-planar structures being composed of a first material;
a core layer over the non-planar structures composed of a second material; and
a third material formed over the core layer.

2. The structure of claim 1, wherein the first material has a first refractive index and the second material has a second refractive index larger than the first refractive index.

3. The structure of claim 2, wherein the third material is comprised of air.

4. The structure of claim 3, wherein the third material has a third refractive index less than the second refractive index.

5. The structure of claim 4, wherein the third refractive index is equal to the first refractive index.

6. The structure of claim 1, wherein the second material and the third material have a different refractive index.

7. The structure of claim 1, wherein the non-planar structures, the core layer and the material form a shape that provides a rectilinear path for propagation of an optical wave.

8. The structure of claim 1, wherein the rectilinear path includes horizontal and vertical optical paths for the propagation of the optical wave.

9. The structure of claim 1, wherein the non-planar structures, the core layer and the material form a shape that provides a semi-circular path for propagation of an optical wave.

10. The structure of claim 9, wherein the semi-circular path includes an arc shaped path for the propagation of the optical wave.

11. The structure of claim 10, wherein the semi-circular path includes two arc shaped paths, with a vertical path therebetween.

12. A structure, comprising:
a plurality of cladded core structures configured to propagate an optical wave in a non-planar geometry; and
an upper layer formed over the cladded core structures, the core structures and the upper layer patterned into multiple non-planar waveguide structures.

13. The structure of claim 12, wherein the plurality of cladded core structures includes a material having a first refractive index and a core material having a second refractive index, and the upper layer is comprised of a material having a third refractive index.

14. The structure of claim 13, wherein the second refractive index is different from the first and third refractive indexes.

15. The structure of claim 14, wherein the second refractive index is greater than the first and third refractive indexes.

16. The structure of claim 13, wherein the first and second refractive indexes are different.

17. The structure of claim 13, wherein the geometry is a vertical direction and a horizontal direction.

18. The structure of claim 13, wherein the geometry is a rectilinear path or a semi-circular path for propagation of an optical wave.

19. The structure of claim 18, wherein the semi-circular path includes at least one arc shaped path leading to a vertical extent for the propagation of the optical wave.

20. A method, comprising:
forming non-planar structures having a reduced horizontal length in a planar direction in comparison to a vertical length in a non-planar direction and the non-planar structures being composed of a first material which provide a non-planar optical path for an optical wave;
forming a cladding layer over the non-planar structures composed of a second material;
forming a third material formed over the cladding layer; and
patterning the non-planar structures and the third material into multiple non-planar waveguide structures.
